(19) United States
(12) Patent Application Publication
(10) Pub. No.: US 2015/0170350 A1
(43) Pub. Date: Jun. 18, 2015

(54) Method And Apparatus For Estimating Motion Homogeneity For Video Quality Assessment

(71) Applicant: THOMSON LICENSING, Issy de Moulineaux (FR)

(72) Inventors: Fan Zhang, Hubei (CN); Ning Liao, Beijing (CN); Xiaodong Gu, Beijing (CN); Zhibo Chen, Beijing (CN)

(21) Appl. No.: 14/417,984

(22) PCT Filed: Jun. 14, 2013
(86) PCT No.: PCT/CN2013/077262

§ 371 Date: Jan. 28, 2015

(30) Foreign Application Priority Data
Aug. 27, 2012 (CN) PCT/CN2012/080627

(51) Int. Cl. G06T 7/00

(52) U.S. Cl. CPC G06T 7/0002; G06T 2207/10016; G06T 2207/30168

(57) ABSTRACT

When a scene moves homogeneously or fast, human eyes become sensitive to freezing artifacts. To measure the strength of motion homogeneity, a panning homogeneity parameter is estimated to account for isotropic motion vectors, for example, caused by camera panning, tilting, and translation, a zooming homogeneity 5 parameter is estimated for radial symmetric motion vectors, for example, caused by camera zooming, and a rotation homogeneity parameter is estimated for rotational symmetric motion vectors, for example, caused by camera rotation. Subsequently, an overall motion homogeneity parameter is estimate based on the panning, zooming, and rotation homogeneity parameters. A freezing distortion factor can then 10 be estimated using the overall motion homogeneity parameter. The freezing distortion factor, combined with compression and slicing distortion factors, can be used to estimate a video quality metric. parameter

### CROSS-REFERENCE TO RELATED APPLICATIONS

This application claims the benefit of WO International Application No. PCT/CN2012/080627, filed Aug. 27, 2012.

### TECHNICAL FIELD

This invention relates to video quality measurement, and more particularly, to a method and apparatus for determining a video quality metric in response to motion information. The determined video quality metric can then be used, for example, to adjust encoding parameters, or to provide the required video quality at the receiver side.

### BACKGROUND

Human perception of freezing artifacts(i.e., visual pauses) is closely related to motion of a scene. When a scene moves homogeneously or fast, human eyes become sensitive to freezing artifacts.

In a commonly owned PCT application, entitled “Video Quality Measurement” by F. Zhang, N. Liao, K. Xie, and Z. Chen (PCT/CN2011/082870, Attorney Docket No. PA110050, hereinafter “Zhang”), the teachings of which are specifically incorporated herein by reference, we disclosed a method for estimating a compression distortion factor, a slicing distortion factor, and a freezing distortion factor using parameters (for example, quantization parameters, content unpredictability parameters, ratios of lost blocks, ratios of propagated blocks, error concealment distances, motion vectors, durations of freezing, and frame rates) derived from a bitstream.

### SUMMARY

The present principles provide a method for generating a quality metric for a video included in a bitstream, comprising the steps of: accessing motion vectors for a picture of the video; determining a motion homogeneity parameter responsive to the motion vectors; and determining the quality metric responsive to the motion homogeneity parameter as described below. The present principles also provide an apparatus for performing these steps.

The present principles also provide a method for generating a quality metric for a video included in a bitstream, comprising the steps of: accessing motion vectors for a picture of the video; determining a motion homogeneity parameter responsive to the motion vectors, wherein the motion homogeneity parameter is indicative of strength of homogeneity for at least one of isotropic motion vectors, radial symmetric motion vectors, and rotational symmetric motion vectors; determining a freezing distortion factor in response to the motion homogeneity parameter; and determining the quality metric responsive to the freezing distortion factor as described below. The present principles also provide an apparatus for performing these steps.

The present principles also provide a computer readable storage medium having stored thereon instructions for generating a quality metric for a video included in a bitstream, according to the methods described above.

### BRIEF DESCRIPTION OF THE DRAWINGS

FIG. 1 is a pictorial example depicting different camera movements, corresponding motion fields, and scales of panning, zooming, and rotation homogeneity parameters (IH, RH, and AH), in accordance with an embodiment of the present principles.

FIGS. 2A and 2B are pictorial examples depicting radial projection and angular projection, respectively.

FIG. 3 is a flow diagram depicting an example for estimating video quality based on motion homogeneity, in accordance with an embodiment of the present principles.

FIG. 4 is a block diagram depicting an example of a video quality measurement apparatus that may be used with one or more implementations of the present principles.

FIG. 5 is a block diagram depicting an example of a video processing system that may be used with one or more implementations of the present principles.

### DETAILED DESCRIPTION

Homogenous motions, even slow, can draw attention of human eyes. When a video decoder freezes decoding, for example, when the picture data or the reference picture is lost, and thus causes a visual pause, human perception of the freezing artifact or the visual pause is closely related to motion of a scene. When a scene moves homogeneously or fast, human eyes become sensitive to freezing artifacts.

Camera movement often causes homogenous motions in a scene. A typical set of basic camera operations includes pan, tilt, rotate/swing, translation/track/boom, and dolly/zoom, in which pan, tilt, and swing are rotation around Y-, X-, and Z-axis respectively, while boom and dolly are translation along Y- and Z-axis respectively. When capturing content, camera movement usually is not very large, and multiple types of camera operations are seldom performed at the same time. Therefore, camera operations can often be regarded as consisting of a single type of movement, for example, pan, boom, or translation only.

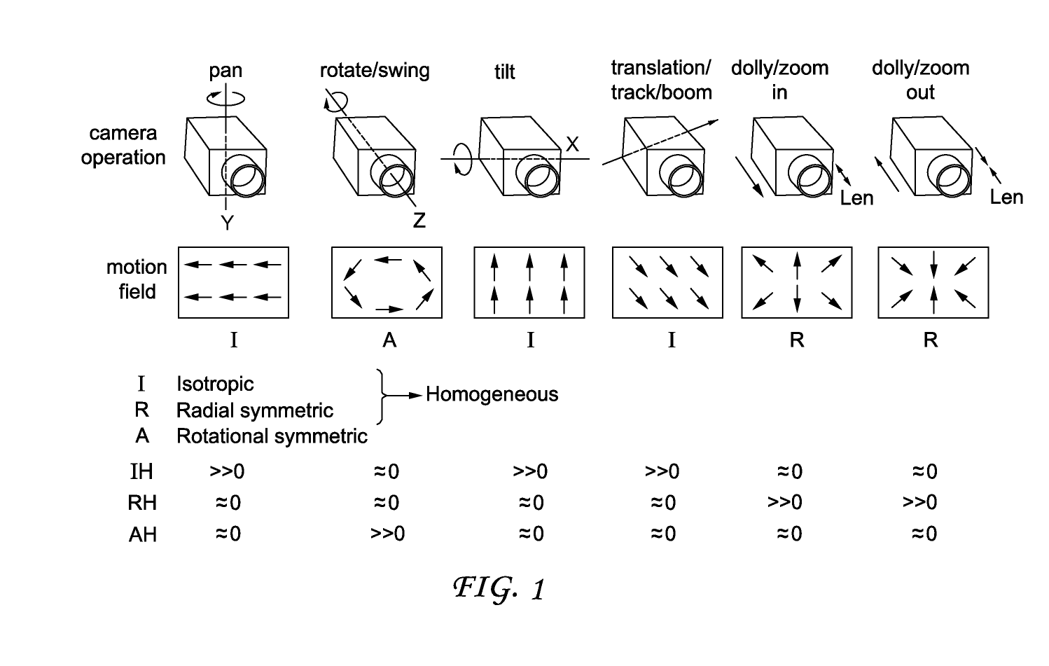

FIG. 1 illustrates various camera operations and exemplary resultant motion fields in a picture. Generally, three types of motion fields occur: A) isotropic motion fields by pan, tilt and translation/track/boom; B) radial symmetric motion fields by dolly/zoom; and C) rotational symmetric motion fields by rotate/swing. All above motion fields show homogeneous motions, where motion vectors of a current area in the picture do not differ much from the motion vectors of neighboring areas. In one example, when a camera pans, the captured video shows homogenous motions, with motion vectors pointing to substantially similar directions at substantially similar magnitudes. In another example, when a camera rotates, the captured video also shows homogenous motions, with motion vectors rotates along the same direction (i.e., clockwise or anticlockwise) at substantially similar angular speeds. For human eyes, homogenous motion may exhibit an obvious motion trend because the motion vectors are substantially uniform or consistent throughout the picture. This may be why when a scene with homogeneous motions freezes, the freezing artifact is obvious to human eyes because the human eyes expect the motion trend to continue.

In addition, foreground and background objects may also cause homogeneous motions, for example, we may see homogenous motions in a video with a bus driving by or a windmill wheeling around.

In the present application, we determine a motion homogeneity parameter for a video segment from motion vectors (MVs), and use the motion homogeneity parameter to estimate a freezing distortion factor for a video sequence. In particular, the motion homogeneity parameter is used to measure how homogenous the motion vectors are in the video, and the freezing distortion factor is used to measure the freezing distortion.

Most existing video compression standards, for example, H.264 and MPEG-2, use a macroblock (MB) as the basic encoding unit. Thus, the following embodiments use a macroblock as the basic processing unit. However, the principles may be adapted to use a block at a different size, for example, an 8×8 block, a 16×8 block, a 32×32 block, or a 64×64 block.

In order to determine the motion homogeneity parameter, the motion vectors are pre-processed. For example, MVs are normalized by the interval between a predicted picture and a corresponding reference picture, and their signs are reversed if the MVs are backward-referencing. If a macroblock is intra predicted and thus has no MV, we set the MV for the MB as the MV of a collocated MB in the nearest previous picture (i.e., the MB at the same position as the current MB in the nearest previous picture) in the displaying order. For a bi-directionally predicted MB in B-pictures, we set the MV for the MB as the average of the two MVs, which are normalized by the interval between the predicted picture and the reference picture.

Subsequently, we define several homogeneity parameters to account for different types of motion fields. In the following, the homogeneity parameters for isotropic motion, radial symmetric motion, and rotational symmetric motion are discussed in detail.

### A) Isotropic

A panning homogeneity parameter, denoted as IH, is used to quantify strength of motion homogeneity associated with isotropic motion vectors. Using H.264 as an example, for an individual picture, a vector mean of all MVs in the picture can be defined as:

$${MV}_{vm , x} = \frac{1}{H \cdot W} ( {\sum }_{r ∈ τ}^{ } {\sum }_{l ⋐ r}^{ } {MV}_{h , l , r} \cdot {A}_{l , r} ) , \\ {MV}_{vm , y} = \frac{1}{H \cdot W} ( {\sum }_{r ∈ τ}^{ } {\sum }_{l ⋐ r}^{ } {MV}_{v , l , r} \cdot {A}_{l , r} ) , \qquad ( 1 )$$

where r indexes the MBs in the closest unimpaired picture before the τ-th pause and I indexes the partitions in the r-th MB; MV_{h,i,r} and MV_{v,l,r} denote horizontal and vertical components of the MV of the I-th partition in the r-th MB respectively; A_{l,r} denotes the area (for example, the number of pixels) of the I-th partition in the r-th MB; and constants H and W are the height and width of the picture.

IH can then be defined as the magnitude of the vector mean of all MVs in the picture as:

$${IH}_{τ} = \frac{1}{H \cdot W} \sqrt{{( {\sum }_{r ∈ τ}^{ } {\sum }_{l ⋐ r}^{ } {MV}_{h , l , r} \cdot {A}_{l , r} )}^{2} + {( {\sum }_{r ∈ τ}^{ } {\sum }_{l ⋐ r}^{ } {MV}_{v , l , r} \cdot {A}_{l , r} )}^{2}} . \qquad ( 2 )$$

That is, the panning homogeneity parameter relates to the size of regions in the picture that have isotopic motions, how well the motion matches the motion trend seen by human eyes, and the magnitudes of the motion vectors. For example, IH becomes greater when the camera pans, tilts, booms, translates or tracks faster. IH also becomes greater when a large foreground or background object in the scene translates.

### B) Radial Symmetric

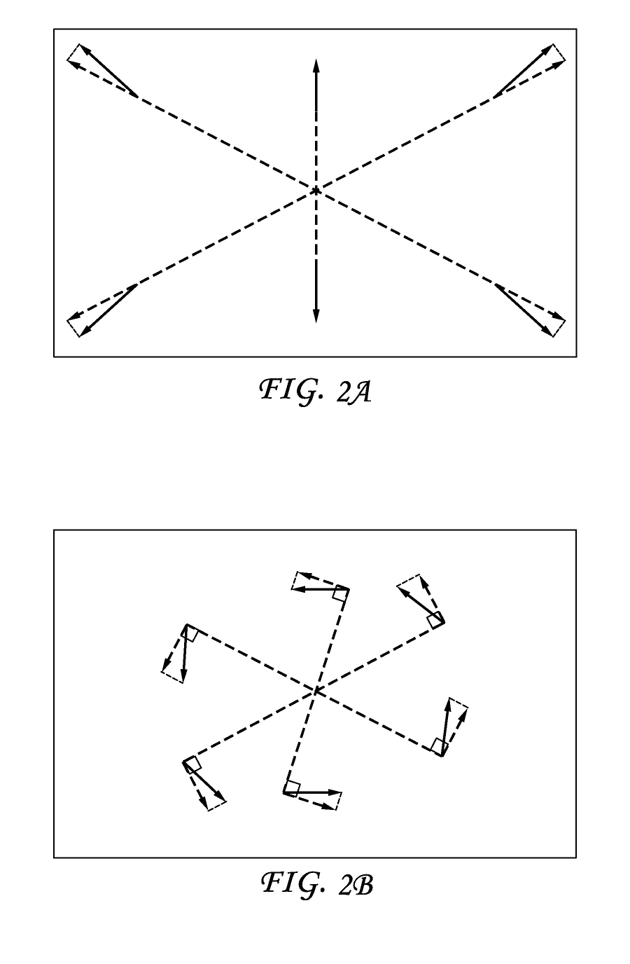

A zooming/dollying homogeneity parameter, denoted as RH, is used to quantify strength of motion homogeneity associated with radial symmetric motion vectors. In a radial symmetric MV field, supposing the picture center as pole, all MVs present consistent radial velocities. In one embodiment, RH can be defined as the mean of all MVs' radial projections as:

$${RH}_{τ} = \frac{1}{H \cdot W} \vert {\sum }_{( x , y ) ∈ τ}^{ } {\sum }_{l ⋐ ( x , y )}^{ } \frac{[ \begin{matrix}{MV}_{h , l , x , y} ( x - \frac{W}{2} ) + \\ {MV}_{v , l , x , y} ( y - \frac{H}{2} )\end{matrix} ] {A}_{l , x , y}}{\sqrt{{( x - \frac{W}{2} )}^{2} + {( y - \frac{H}{2} )}^{2}}} \vert , \qquad ( 3 )$$

where (x,y) indexes the MB in terms of the MB's Cartesian coordinate and I indexes the partitions in MB (x,y); MV_{h,l,x,y} and MV_{v,i,x,y}denote the horizontal and vertical components of the MV of the I-th partition in MB (x,y), respectively; and A_{l,x,y} denotes the area (for example, the number of pixels) of the I-th partition in MB (x,y). In FIG. 2A, an example of radial projection is shown, wherein MVs are represented by solid arrowed lines, and radial projections of the MVs are represented by dashed arrowed lines.

RH can also be calculated in a different way. Firstly, the difference between the sum of horizontal components of MVs in the left half picture and those in the right half picture, and the difference between the sum of vertical components of MVs in the top half picture and those in the bottom half picture are both calculated. Secondly, the two difference values are both normalized by the total number of MB in a picture, and form a 2D vector. Thirdly, RH is set as the magnitude of the formed 2D vector:

$${RH}_{τ} = \frac{1}{H \cdot W} \sqrt{\begin{matrix}{\vert {\sum }_{r ∈ {τ}_{L}}^{ } {\sum }_{l ⋐ r}^{ } {MV}_{h , l , r} {A}_{l , r} - {\sum }_{r ∈ {τ}_{R}}^{ } {\sum }_{l ⋐ r}^{ } {MV}_{h , l , r} {A}_{l , r} \vert}^{2} + \\ {\vert {\sum }_{r ∈ {τ}_{T}}^{ } {\sum }_{l ⋐ r}^{ } {MV}_{v , l , r} {A}_{l , r} - {\sum }_{r ∈ {τ}_{B}}^{ } {\sum }_{l ⋐ r}^{ } {MV}_{v , l , r} {A}_{l , r} \vert}^{2}\end{matrix}} \qquad ( 4 )$$

where τ_{L}, τ_{R}, τ_{T}, and τ_{E} represent the left, right, top and bottom half plane of the τ-th picture, respectively.

That is, the panning homogeneity parameter relates to the size of regions in the picture that have radial symmetric motions, how well the motion matches the motion trend seen by human eyes, and the magnitudes of the motion vectors. For example, RH becomes larger if a camera dolls or zooms faster. RH also becomes larger when a large foreground or background object follows radial symmetric motion.

### C) Rotational Symmetric

In a rotational symmetric MV field, all MVs present consistent angular velocities. In FIG. 2B, an example of angular projection is shown, where MVs are represented by solid arrowed lines, and angular projections of the MVs are by dashed arrowed lines.

A rotation homogeneity parameter, denoted as AH, is used to quantify the strength of motion homogeneity associated with rotational symmetric motion vectors. AH can be defined as the mean of all MVs' angular projections as:

$${AH}_{τ} = \frac{1}{HW} \vert {\sum }_{( x , y ) ∈ τ}^{ } {\sum }_{l ⋐ ( x , y )}^{ } \frac{[ {MV}_{v , l , x , y} ( x - \frac{W}{2} ) - {MV}_{h , l , x , y} ( y - \frac{H}{2} ) ] {A}_{l . x . y}}{\sqrt{{( x - \frac{W}{2} )}^{2} + {( y - \frac{H}{2} )}^{2}}} \vert . \qquad ( 5 )$$

AH can also be calculated in a different way. Firstly, the difference between the sum of vertical components of MVs in the left half picture and those in the right half picture, and the difference between the sum of horizontal components of MVs in the top half picture and those in the bottom half picture are both calculated. Secondly, the two difference values are both normalized by the total number of MB in a picture, and form a 2D vector. Thirdly, AH is set as the magnitude of the formed 2D vector:

$${AH}_{τ} = \frac{1}{HW} \sqrt{\begin{matrix}{\vert {\sum }_{r ∈ {τ}_{L}}^{ } {\sum }_{l ⋐ r}^{ } {MV}_{v , l , r} {A}_{l , r} - {\sum }_{r ∈ {τ}_{R}}^{ } {\sum }_{l ⋐ r}^{ } {MV}_{v , l , r} {A}_{l , r} \vert}^{2} + \\ {\vert {\sum }_{r ∈ {τ}_{T}}^{ } {\sum }_{l ⋐ r}^{ } {MV}_{h , l , r} {A}_{l , r} - {\sum }_{r ∈ {τ}_{B}}^{ } {\sum }_{l ⋐ r}^{ } {MV}_{h , l , r} {A}_{l , r} \vert}^{2}\end{matrix}} . \qquad ( 6 )$$

That is, the panning homogeneity parameter relates to the size of regions in the picture that have rotational symmetric motions, how well the motion matches the motion trend seen by human eyes, and the magnitudes of the motion vectors. For example, AH becomes larger when a camera rotates/swings faster. AH also becomes larger when a large foreground or background object rotates faster.

In FIG. 1, we also illustrate scales of IH, RH, and AH for motion fields caused by different camera movements, where “≈0” means that corresponding values are small, and “>>0” means that corresponding values are larger. For pan, tilt, and translation/track/boom, RH and AH are small and IH is larger; for rotate/swing, IH and RH are small and AH is larger; and for dolly/zoom in and dolly/zoom out, IH and AH are small and RH is larger. That is, the panning, zooming, and rotation homogeneity parameters effectively capture strengths of homogeneity for corresponding motion fields.

In the above, we discuss motion homogeneity parameters for pictures with homogeneous motions, such as isotropic motion vectors, radial symmetric motion vectors, and rotational symmetric motion vectors, respectively. The parameters relate to the size of regions with homogeneous motions, how well the motion matches the motion trend seen by human eyes, and the magnitudes of the motion vectors. In another variation, we may normalize the motion vectors, such that the motion homogeneity parameters mainly reflects the size of regions with homogeneous motions and how well the motion matches the motion trend seen by human eyes, that is, the motion homogeneity parameters become independent of motion magnitudes.

In the above, motion vectors in an unimpaired picture before the τ-th pause are used for calculating motion homogeneity parameters. In other variations, motion vectors from pictures during and after the pause can be used.

After homogeneity parameters for different types of motion fields are obtained, the overall motion homogeneity of the T-th picture can be defined, for example, as the maximum among panning, zooming, and rotation homogeneity parameters:

MH_{τ}=max{IH_{τ}, α₁, RH₉₆ , α₂, AH_{τ}}, (7)

where parameters α₁ and α₂ are to balance homogeneity parameters among the three different types of homogenous motions. We empirically set them both to 1, for the simplified formula (3) and (5). In Eq. (7), IH, RH, and AH are all considered. In other variations, we may use only one or two of these three parameters to derive the overall motion homogeneity parameter.

In other embodiments, other functions may be used to derive the overall motion homogeneity parameter based on IH, AH, and RH, such as a Sum or arithmetic mean function (MH_{τ}=IH_{τ}+α₁·RH_{τ}+α₂·AH_{τ}), a harmonic mean function

$$( {MH}_{τ} = 1 / ( \frac{1}{{IH}_{τ}} + \frac{1}{{α}_{1} \cdot {RH}_{τ}} + \frac{1}{{α}_{2} \cdot {AH}_{τ}} ) ) ,$$

a product or geometric mean function, (MH_{τ}=IH_{τ}·RH_{τ}·AH_{τ}), or a sum of absolute differences (MH_{τ}=↑IH_{τ}−α₁·RH_{τ+|IH}_{τ}−α₂·AH_{τ}|+|α₁·RH_{τ}−α₂·AH_{τ}|).

The motion homogeneity parameter of a video clip can be calculated as the average MH_{τ} of all visual pauses within the clip. For example, it may be calculated as:

z_{f}=MH_{T}=1/TΣ_{τ}MH_{τ}, (8)

where T is the total number of the visual pauses, and τ indexes the visual pause.

The motion homogeneity parameter can be used to predict a freezing distortion factor for a video sequence. For example, z_{f} (i.e, MH_{T}) may replace MV_{T} in Eq. (5) of Zhang (PCT/CN2011/082870) to calculate a freezing distortion factor. That is,

d_{f}=e^{b}^{₆}^{FR}×(log MH_{T})^{b}^{₇}×FD_{T}^{b}^{₈}, (9)

wherein FR is the frame rate, FD_{T} is freezing duration, and b₆, b₇ and b₈ are constants.

Combining the freezing distortion factor and other distortion factors (for example, compression distortion factor and slicing distortion factor), an overall video quality metric can be obtained for the video sequence. Since motion vectors are available in a bitstream, the video quality measurement according to the present principles may be implemented on a bitstream level.

In addition, we notice that the freezing distortion caused by a final visual pause (a pause lasting until the end of a video clip), if short, is usually not annoying to human eyes. In one embodiment, a final pause that is shorter than 2 seconds is not taken into account when computing the freezing distortion factor.

Using z_{f}, and other parameters, a quality metric may also be calculated as:

$$q = \frac{{MOS}_{ub} - {MOS}_{lb}}{1 + {α ( {a}_{c} {x}_{c}^{{b}_{c 0}} {z}_{c}^{{b}_{c 1}} + {a}_{f} {x}_{f}^{{b}_{f 0}} {z}_{f}^{{b}_{f 1}} + {a}_{s} {x}_{s}^{{b}_{s 0}} {z}_{x}^{{b}_{s 1}} )}^{β}} + {MOS}_{lb} , \qquad ( 10 )$$

where output variable q is the predicted quality score; constants MOS_{ub} and MOS_{lb} are the upper bound and lower bound of MOS (Mean Opinion Score), i.e., 5 and 1, respectively; α, β, {a} and {b} are model parameters (a_{c}=1 constantly); subscripts c, f and s indicate compression, freezing and slicing impairments respectively; variables {x} and {z} are model factors and also generally termed as features, which are extracted from video data. To be specific, {x} and {z} are respectively the key factor and the co-variate associated with each type of impairment, for example., x_{c} is the key factor for compression impairment and zₛ is the co-variate for slicing impairment.

The motion homogeneity parameter can also be used in other applications, for example, but not limited to, shot segmentation, video fingerprint, and video retrieval.

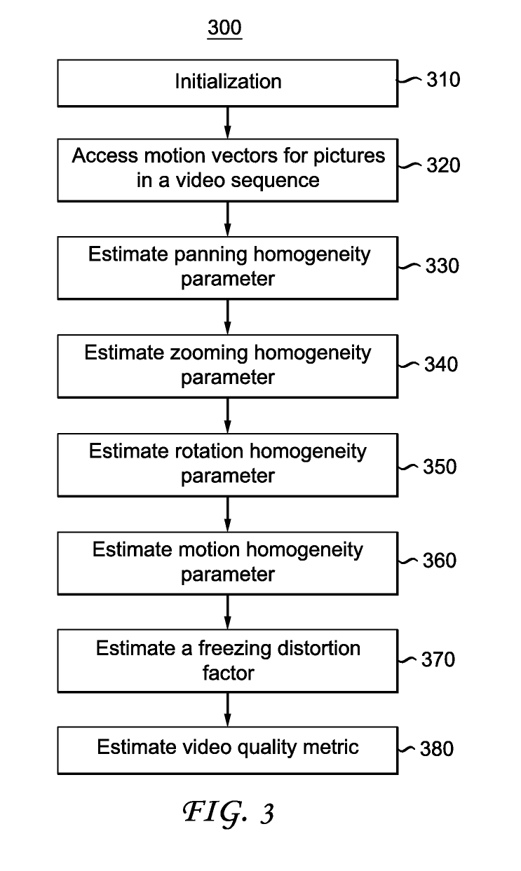

FIG. 3 illustrates an exemplary method 300 for measuring motion homogeneity parameter for video quality measurement. Method 300 starts at initialization step 310. At step 320, motion vectors for the pictures are accessed, for example, from a bitstream. At step 330, a panning homogeneity parameter is estimated, for example, using Eq. (2). At step 340, a zooming homogeneity parameter is estimated, for example, using Eq. (3) or (4). At step 350, a rotation homogeneity parameter is estimated, for example, using Eq. (5) or (6). At step 360, motion homogeneity parameters are estimated for individual pictures and for the video sequence, for example, using Eqs. (7) and (8), respectively. Based on the motion homogeneity parameter for the video sequence, a freezing distortion factor is estimated at step 370, for example, using Eq. (9). Combining the freezing distortion factor with compression and/or slicing distortion factors, an overall video quality metric can be estimated at step 380, for example, using Eq. (10).

Method 300 may be varied from what is shown in FIG. 3 in terms of the number of combination of the panning, zooming, and rotation homogeneity parameters, or the order in which estimating steps are performed as long as the required parameters are determined.

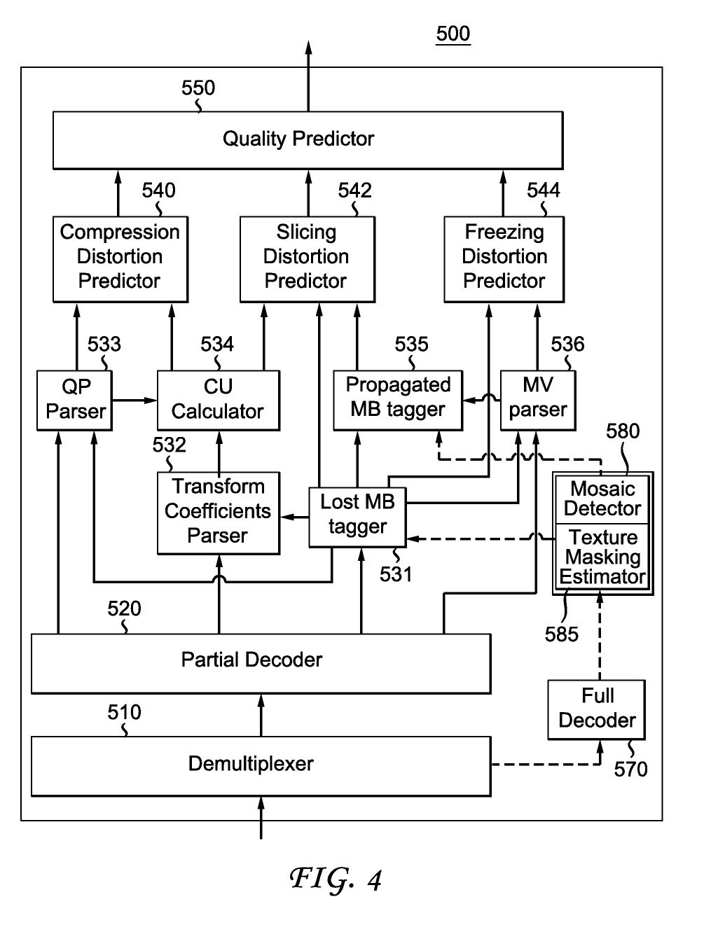

FIG. 4 depicts a block diagram of an exemplary video quality measurement apparatus 500 that can be used to generate a video quality metric for a video sequence. The input of apparatus 500 includes a transport stream that contains the bitstream. The input may be in other formats that contains the bitstream. A receiver at the system level determines packet losses in the received bitstream.

Demultiplexer 510 parses the input stream to obtain the elementary stream or bitstream. It also passes information about packet losses to the decoder 520. The decoder 520 parses necessary information, including QPs, transform coefficients, and motion vectors for each block or macroblock, in order to generate parameters for estimating the quality of the video. The decoder also uses the information about packet losses to determine which macroblocks in the video are lost. Decoder 520 is denoted as a partial decoder to emphasize that full decoding is not performed, i.e., the video is not reconstructed.

Using the MB level QPs parsed from decoder 520, a QP parser 533 obtains average QPs for pictures and for the entire video clip. Using transform coefficients obtained from decoder 520, a transform coefficients parser 532 parses the coefficients and a content unpredictability parameter calculator 534 calculates the content unpredictability parameter for individual pictures and for the entire video clip. Using the information about which macroblocks are lost, a lost MB tagger 531 marks which MB is lost. Further using motion information, a propagated MB tagger 535 marks which MBs directly or indirectly use the lost blocks for prediction (i.e., which blocks are affected by error propagation). Using motion vectors for blocks, an MV parser 536 calculates a motion homogeneity parameter for individual pictures and the entire video clip, for example, using method 300. Other modules (not shown) may be used to determine error concealment distances, durations of freezing, and frame rates.

A compression distortion predictor 540 estimates a compression distortion factor, a slicing distortion predictor 542 estimates a slicing distortion factor, and a freezing distortion predictor 544 estimates a freezing distortion factor. Based on the estimated distortion factors, a quality predictor 550 estimates an overall video quality metric.

When extra computation is allowed, a decoder 570 decodes the pictures. The decoder 570 is denoted as a full decoder and it will reconstruct the pictures and perform error concealment if necessary. A mosaic detector 580 performs mosaic detection on the reconstructed video. Using the mosaic detection results, the lost MB tagger 531 and the propagated MB tagger 535 update relevant parameters, for example, the lost block flag and the propagated block flag. A texture masking estimator 585 calculates texture masking weights. The texture masking weights can be used to weigh the distortions.

The video quality measurement apparatus 500 may be used, for example, in ITU-T P.NBAMS (parametric non-intrusive bitstream assessment of video media streaming quality) standard, which works on video quality assessment models in two application scenarios, namely, IPTV and mobile video streaming, also called HR (High Resolution) scenario and LR (Low Resolution) scenario respectively. The difference between the two scenario ranges from the spatio-temporal resolution of video content and coding configuration to transport protocols and viewing conditions.

The input to the P.NBAMS VQM (Video Quality Model) is coded video bitstream with all transmission packet headers (UDP/IP/RTP or UDP/IP/RTP/TS). The output is an objective MOS score. A major target application of P.NBAMS work is to monitor video quality in a set-top box (STB) or gateway. P.NBAMS mode 1 model only uses bitstream information, and mode 2 model may decode parts or all of the video sequence, and the pixel information is used for visual quality prediction in addition to parsing the bitstream information in order to improve the prediction accuracy.

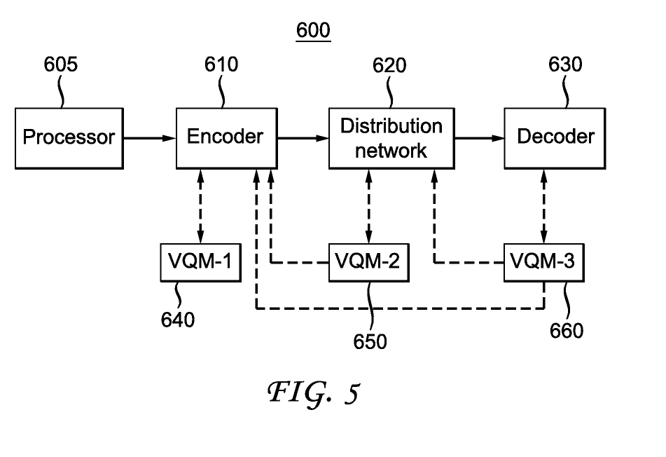

Referring to FIG. 5, a video transmission system or apparatus 600 is shown, to which the features and principles described above may be applied. A processor 605 processes the video and the encoder 610 encodes the video. The bitstream generated from the encoder is transmitted to a decoder 630 through a distribution network 620. A video quality monitor or a video quality measurement apparatus, for example, the apparatus 500, may be used at different stages.

In one embodiment, a video quality monitor 640 may be used by a content creator. For example, the estimated video quality may be used by an encoder in deciding encoding parameters, such as mode decision or bit rate allocation. In another example, after the video is encoded, the content creator uses the video quality monitor to monitor the quality of encoded video. If the quality metric does not meet a pre-defined quality level, the content creator may choose to re-encode the video to improve the video quality. The content creator may also rank the encoded video based on the quality and charges the content accordingly.

In another embodiment, a video quality monitor 650 may be used by a content distributor. A video quality monitor may be placed in the distribution network. The video quality monitor calculates the quality metrics and reports them to the content distributor. Based on the feedback from the video quality monitor, a content distributor may improve its service by adjusting bandwidth allocation and access control.

The content distributor may also send the feedback to the content creator to adjust encoding. Note that improving encoding quality at the encoder may not necessarily improve the quality at the decoder side since a high quality encoded video usually requires more bandwidth and leaves less bandwidth for transmission protection. Thus, to reach an optimal quality at the decoder, a balance between the encoding bitrate and the bandwidth for channel protection should be considered.

In another embodiment, a video quality monitor 660 may be used by a user device. For example, when a user device searches videos in Internet, a search result may return many videos or many links to videos corresponding to the requested video content. The videos in the search results may have different quality levels. A video quality monitor can calculate quality metrics for these videos and decide to select which video to store. In another example, the decoder estimates qualities of concealed videos with respect to different error concealment modes. Based on the estimation, an error concealment that provides a better concealment quality may be selected by the decoder.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for generating a quality metric for a video included in a bitstream, comprising the steps of:
accessing motion vectors for a picture of the video;
determining a motion homogeneity parameter responsive to the motion vectors; and
determining the quality metric responsive to the motion homogeneity parameter.

2. The method of claim 1, further comprising:
determining a freezing distortion factor in response to the motion homogeneity parameter, wherein the quality metric is determined responsive to the freezing distortion factor.

3. The method of claim 1, wherein the motion homogeneity parameter is indicative of strength of homogeneity for at least one of isotropic motion vectors, radial symmetric motion vectors, and rotational symmetric motion vectors.

4. The method of claim 1, wherein the motion homogeneity parameter is indicative of strength of homogeneity for motions caused by camera operations, which include at least one of pan, rotation, tilt, translation, zoom in, and zoom out.

5. The method of claim 1, where the step of determining the motion homogeneity parameter further comprises:
determining at least one of a panning homogeneity parameter, a zooming homogeneity parameter, and a rotation homogeneity parameter in response to the motion vectors.

6. The method of claim 5, wherein the zooming homogeneity parameter is determined responsive to radial projections of the motion vectors.

7. The method of claim 5, wherein the step of determining the zooming homogeneity parameter comprises:
determining a first difference between a sum of horizontal components of motion vectors in a left half picture and in a right half picture, and a second difference between a sum of vertical components of motion vectors in a top half picture and in a bottom half picture, wherein the zooming homogeneity parameter is determined in response to the first and second differences.

8. The method of claim 5, wherein the rotation homogeneity parameter is determined responsive to angular projections of the motion vectors.

9. The method of claim 5, wherein the step of determining the rotation homogeneity parameter comprises:
determining a first difference between a sum of vertical components of motion vectors in a left half picture and in a right half picture, and a second difference between a sum of horizontal components of motion vectors in a top half picture and in a bottom half picture, wherein the rotation homogeneity parameter is determined in response to the first and second differences.

10. The method of claim 5, wherein the motion homogeneity parameter is determined to be at least one of a maximum function and a mean function responsive to the at least one of the panning homogeneity parameter, the zooming homogeneity parameter, and the rotation homogeneity parameter.

11. The method of claim 1, further comprising:
performing at least one of monitoring quality of the bitstream, adjusting the bitstream in response to the quality metric, creating a new bitstream based on the quality metric, adjusting parameters of a distribution network used to transmit the bitstream, determining whether to keep the bitstream based on the quality metric, and choosing an error concealment mode at a decoder.

12. An apparatus for generating a quality metric for a video included in a bitstream, comprising:
a decoder configured to access motion vectors for a picture of the video;
a motion vector parser configured to determine a motion homogeneity parameter responsive to the motion vectors; and
a quality predictor configured to determine a quality metric responsive to the motion homogeneity parameter.

13. The apparatus of claim 12, further comprising:
a slicing distortion predictor configured to determine a freezing distortion factor in response to the motion homogeneity parameter, wherein the quality metric is determined responsive to the freezing distortion factor.

14. The apparatus of claim 12, wherein the motion homogeneity parameter is indicative of strength of homogeneity for at least one of isotropic motion vectors, radial symmetric motion vectors, and rotational symmetric motion vectors.

15. The apparatus of claim 12, wherein the motion homogeneity parameter is indicative of strength of homogeneity for motions caused by camera operations, which include at least one of pan, rotation, tilt, translation, zoom in, and zoom out.

16. The apparatus of claim 12, where the motion vector parser is configured to determine at least one of a panning homogeneity parameter, a zooming homogeneity parameter, and a rotation homogeneity parameter in response to the motion vectors.

17. The apparatus of claim 15, wherein motion vector parser is configured to determine the zooming homogeneity parameter responsive to radial projections of the motion vectors.

18. The apparatus of claim 15, wherein the motion vector parser is configured to determine a first difference between a sum of horizontal components of motion vectors in a left half picture and in a right half picture, and a second difference between a sum of vertical components of motion vectors in a top half picture and in a bottom half picture, wherein the zooming homogeneity parameter is determined in response to the first and second differences.

19. The apparatus of claim 15, wherein the rotation homogeneity parameter is determined responsive to angular projections of the motion vectors.

20. The apparatus of claim 15, wherein the motion vector parser is configured to determine a first difference between a sum of vertical components of motion vectors in a left half picture and in a right half picture, and a second difference between a sum of horizontal components of motion vectors in a top half picture and in a bottom half picture, wherein the rotation homogeneity parameter is determined in response to the first and second differences.

21. The apparatus of claim 15, wherein the motion vector parser is configured to determine the motion homogeneity parameter to be at least one of a maximum function and a mean function responsive to the at least one of the panning homogeneity parameter, the zooming homogeneity parameter, and the rotation homogeneity parameter.

22. The apparatus of claim 12, further comprising:
a video quality monitor configured to perform at least one of monitoring quality of the bitstream, adjust the bitstream in response to the quality metric, create a new bitstream based on the quality metric, adjust parameters of a distribution network used to transmit the bitstream, determine whether to keep the bitstream based on the quality metric, and choose an error concealment mode at a decoder.

23. (canceled)
